(19) United States
(12) Patent Application Publication
(10) Pub. No.: US 2017/0202401 A1
(43) Pub. Date: Jul. 20, 2017

(54) Hot Pizza Box

(71) Applicant: David Mortell, Malibu, CA (US)

(72) Inventor: David Mortell, Malibu, CA (US)

(21) Appl. No.: 15/333,130

(22) Filed: Oct. 24, 2016

Related U.S. Application Data
(60) Provisional application No. 62/285,176, filed on Oct. 22, 2015.

(51) Int. Cl. A47J 47/14; B65D 81/38; B65D 5/56; B65D 5/66; B65D 5/02; B65D 5/42

(52) U.S. Cl. CPC A47J 47/145; B65D 5/02; B65D 5/4266; B65D 5/563; B65D 5/6602; B65D 5/4295; B65D 81/386

(57) ABSTRACT

A hot pizza box is formed of corrugated cardboard and includes an aluminum liner for the top, bottom, front, back and side panels to help retain heat within the box. A second aluminum liner may be located within the corrugated material of the box either above or below the corrugated material in the box panels. An alternative pizza box is formed of resilient material having interior and exterior members enclosing a cavity. A formed aluminum panel is located in the cavity. The bottom panel of the box has a central aperture penetrating the interior member. The aluminum panel has an opening formed to align with the aperture and a series of channels extends from the opening to edges of the panels. The aperture serves to channel heat from the pizza to the opening in the bottom panel and through the channels to the panels and tabs of the pizza box.

### RELATED APPLICATION

The instant application is a Continuation-in-Part of Provisional Patent Application Ser. No. 62/285,176 filed on Oct. 22, 2015 and claims priority to the filing date thereof and incorporates the disclosure of the application in its entirety.

### FIELD OF INVENTION

This invention relates to the field of packaging, and more specifically to heat-retaining boxes for pizza and other food products.

### BACKGROUND OF THE INVENTION

Pizza has long been provided carry out and delivery in cardboard or paperboard boxes. While such boxes are inexpensive to make and easy to use, they will only keep the pizza at a desirable eating temperature for a short time. The present invention addresses this problem with two designs for a pizza box that will substantially maintain the serving temperature of the pizza for an extended time.

An example of a pizza container invention developed to address the rapid cooling problem associated with carry out and pizza delivery includes U.S. Pat. No. 9,162,808 which discloses an insulated take home food container. The present invention relates to a laminate of metallic or non-metallic heat reflective film, either flat or in a manner to create air pockets, utilized to increase the holding time a food stays warm in the container. The container can have flat surface or dividing walls depending on the use of the box.

It is an objective of the present invention to provide a pizza box suitable for carry out and delivery use that will maintain the pizza at an elevated temperature for an extended period of time. It is a further objective to provide a box that is inexpensive to make and efficient to use. It is a still further objective of the invention to provide a box that can be stored and shipped in a flattened configuration. It is yet a further objective to provide such a box that is quickly and easily assembled from flat configuration into a box. Finally, it is an objective of the present invention to provide a box that can be manufactured from easily recycled materials or that can be recycled for additional uses.

While some of the objectives of the present invention are disclosed in the prior art, none of the inventions found include all of the requirements identified.

### SUMMARY OF THE INVENTION

The present invention addresses all of the deficiencies of prior art dispensers for hot pizza boxes and satisfies all of the objectives described above.

(1) A hot pizza box providing the desired features may be constructed from the following components. A bottom panel is provided. The bottom panel is sized and shaped to support a pizza. A front panel is provided. The front panel is attached to a front edge of the bottom panel along a first perforation line. A first bottom side panel is provided. The first bottom side panel is attached to a first side edge of the bottom panel along a second perforation line. A second bottom side panel is provided. The second bottom side panel is attached to a second side edge of the bottom panel along a third perforation line. A back panel is provided. The back panel is attached to a back edge of the bottom panel along a fourth perforation line. A first back panel seal is provided. The first back panel seal is attached to a first end of the first bottom side panel at a fifth perforation line. A second back panel seal is provided. The second back panel seal is attached to a first end of the second bottom side panel at a sixth perforation line.

A top panel is provided. The top panel is attached at a back edge to the back panel along a seventh perforation line. A first top side panel is provided. The first top side panel is attached to a first side edge of the top panel along an eighth perforation line. A second top side panel is provided. The second top side panel is attached to a second side edge of the top panel along a ninth perforation line. A first lid reinforcing tab is provided. The first lid reinforcing tab is attached to a first end of the first top side panel along a tenth perforation line. A second lid reinforcing tab is provided. The second lid reinforcing tab is attached to a first end of the second top side panel along an eleventh perforation line. A lid front panel is provided. The lid front panel attached to a front edge of the top panel along a twelfth perforation line. A lid front panel securing portion is provided. The lid front panel securing portion is attached to the lid front panel along thirteenth and fourteenth parallel perforation lines.

The hot pizza box is formed of corrugated cardboard or paperboard. The bottom panel, front panel, first and second bottom side panels, back panel, first and second back panel seals, and top panel have an aluminum lining on interior surfaces of the panels and seals. The pizza box is formed by folding the front panel to be orthogonal to the bottom panel, folding the first and second back panel seals to be orthogonal to the first and second bottom side panels, respectively, folding the first and second bottom side panels to be orthogonal to the bottom panel, folding the first and second lid reinforcing tabs to be orthogonal to the first and second top side panels, respectively, folding the first and second top side panels to be orthogonal to the top panel, folding the a lid front panel to be orthogonal to the top panel, folding the lid front panel securing portion over the first and second lid reinforcing tabs and securing it frictionally to an interior surface of the top panel, folding the back panel to be orthogonal to the bottom panel and folding the top panel to be orthogonal to the back panel, thereby forming a closed pizza box.

(2) In a variant of the invention, the bottom panel, front panel, first and second bottom side panels, back panel, first and second back panel seals, and top panel further include a second layer of aluminum located between interior and exterior surfaces of the corrugated cardboard or paperboard.

(3) In another variant, the second layer of aluminum is located between the interior surface of the corrugated cardboard or paperboard and a corrugated layer of paper within the corrugated cardboard or paperboard.

(4) In still another variant, the second layer of aluminum is located between the exterior surface of the corrugated cardboard or paperboard and a corrugated layer of paper within the corrugated cardboard or paperboard.

(5) In yet another variant, at least one interruption in the fourth perforation line is provided. The at least one interruption is formed as a first cut through the back panel parallel to and spaced downwardly from the fourth perforation line and connected to the fourth perforation line by second and third cuts orthogonal to the first cut and the fourth perforation line, the first cut reduces the effort required to fold the back panel to be orthogonal to the bottom panel.

(6) In a further variant, at least one vent opening is provided. The vent opening is located in either of the top panel or the bottom panel.

(7) In still a further variant, at least one securing protrusion is provided. The first securing protrusion extends outwardly from a distal edge of the lid front panel securing portion and is adapted to facilitate frictionally securing the lid front panel securing portion to the interior surface of the top panel.

(8) In yet a further variant, an alternative hot pizza box includes the following components. A bottom panel is provided. The bottom panel is sized and shaped to support a pizza. A front panel is provided. The front panel is attached to a front edge of the bottom panel along a first perforation line. A first bottom side panel is provided. The first bottom side panel is attached to a first side edge of the bottom panel along a second perforation line. A second bottom side panel is provided. The second bottom side panel is attached to a second side edge of the bottom panel along a third perforation line. A back panel is provided. The back panel is attached to a back edge of the bottom panel along a fourth perforation line. A first back panel seal is provided. The first back panel seal is attached to a first end of the first bottom side panel at a fifth perforation line. A second back panel seal is provided. The second back panel seal is attached to a first end of the second bottom side panel at a sixth perforation line.

A top panel is provided. The top panel is attached at a back edge to the back panel along a seventh perforation line. A first top side panel is provided. The first top side panel is attached to a first side edge of the top panel along an eighth perforation line. A second top side panel is provided. The second top side panel is attached to a second side edge of the top panel along a ninth perforation line. A first lid reinforcing tab is provided. The first lid reinforcing tab is attached to a first end of the first top side panel along a tenth perforation line. A second lid reinforcing tab is provided. The second lid reinforcing tab is attached to a first end of the second top side panel along an eleventh perforation line. A lid front panel is provided. The lid front panel attached to a front edge of the top panel along a twelfth perforation line. A lid front panel securing portion is provided. The lid front panel securing portion is attached to the lid front panel along thirteenth and fourteenth parallel perforation lines.

The hot pizza box is formed of resilient material and has an exterior member and an interior member. The members are spaced apart to form an interior cavity. The bottom panel has a central aperture. The aperture penetrates only the interior member. The bottom panel, front panel, first and second bottom side panels, back panel, first and second back panel seals, and top panel have a formed aluminum panel located between the interior member and the exterior member.

The pizza box is formed by folding the front panel to be orthogonal to the bottom panel, folding the first and second back panel seals to be orthogonal to the first and second bottom side panels, respectively, folding the first and second bottom side panels to be orthogonal to the bottom panel, folding the first and second lid reinforcing tabs to be orthogonal to the first and second top side panels, respectively, folding the first and second top side panels to be orthogonal to the top panel, folding the a lid front panel to be orthogonal to the top panel, folding the lid front panel securing panel over the first and second lid reinforcing tabs and securing it frictionally to an interior surface of the top panel, folding the back panel to be orthogonal to the bottom panel and folding the top panel to be orthogonal to the back panel, thereby forming a closed pizza box.

(9) In another variant of the invention, the formed aluminum panel further includes a mating recess. The recess is sized and shaped to align with the aperture in the bottom panel;

(10) In still another variant, the formed aluminum panel further includes a series of channels. The channels are adapted to augment heat flow from the aperture to distal ends of the aluminum panel, thereby distributing heat to the panels and seals of the pizza box.

(11) In yet another variant, at least one interruption is provided in the fourth perforation line. The at least one interruption is formed as a first cut through the back panel parallel to and spaced downwardly from the fourth perforation line. The first cut is connected to the fourth perforation line by second and third cuts orthogonal to the first cut and the fourth perforation line, the first cut reduces the effort required to fold the back panel to be orthogonal to the bottom panel.

(12) In a further variant, at least one vent opening is provided. The vent opening is located in either of the top panel or the bottom panel.

(13) In still a further variant, at least one securing protrusion is provided. The first securing protrusion extends outwardly from a distal edge of the lid front panel securing portion. A first receiving notch is provided. The first receiving notch penetrates only the interior member of the top panel and is located and adapted to receive frictionally the first securing protrusion.

(14) In yet a further variant, second and third receiving notches are provided. The second and third receiving notches penetrate the top panel and are located and adapted to receive frictionally inner edges of the first and second lid reinforcing tabs.

(15) In a final variant of the invention, at least one first bottom side panel securing tab and at least one second bottom side panel securing tab are provided. The first and second bottom side panel securing tabs extend upwardly to form the first and second bottom side panels, respectively. At least one first bottom side panel receiving notch and at least one second bottom side panel receiving notch are provided. The first and second bottom side panel receiving notches penetrate the top panel and are located and adapted to receive frictionally the first and second bottom side panel securing tabs, respectively, thereby securing the top panel over the bottom panel.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a plan view of the exterior surface of a punched and perforated cardboard blank which is folded to form a first embodiment of the invention;

FIG. 2 is a plan view of the interior surface of the FIG. 1 embodiment illustrating an aluminum coating on the interior surface of the pizza box to be formed;

FIG. 2A is a cross-sectional view of the FIG. 1 embodiment illustrating the second layer of aluminum disposed between the interior surface of the cardboard and the corrugated paper;

FIG. 2B is a cross-sectional view of the FIG. 1 embodiment illustrating the second layer of aluminum disposed between the exterior surface of the cardboard and the corrugated paper;

FIG. 3 is a plan view of the exterior surface of a punched and perforated cardboard blank which is folded to form a second embodiment of the invention;

FIG. 4 is a plan view of the interior surface of the FIG. 3 embodiment illustrating a heat flow aperture in the interior surface panel of the pizza box to be formed;

FIG. 5 is a plan view of the formed aluminum panel disposed between interior and exterior paperboard panels of the box;

FIG. 5A is a close-up partial plan view of the formed aluminum panel illustrating the flow of heat into the channels from the opening;

FIG. 6 is a perspective view of the assembled pizza box of the FIG. 3 embodiment;

FIG. 7 is a cross-sectional view of the bottom portion of the FIG. 3 embodiment taken along the line 7-7;

FIG. 8 is a cross-sectional view of the lid portion of the FIG. 3 embodiment taken along the line 8-8; and

FIG. 9 is a cross-sectional view of the FIG. 3 embodiment taken along the lines 7-7 and 8-8 with the pizza box closed.

### DETAILED DESCRIPTION OF THE PREFERRED EMBODIMENT

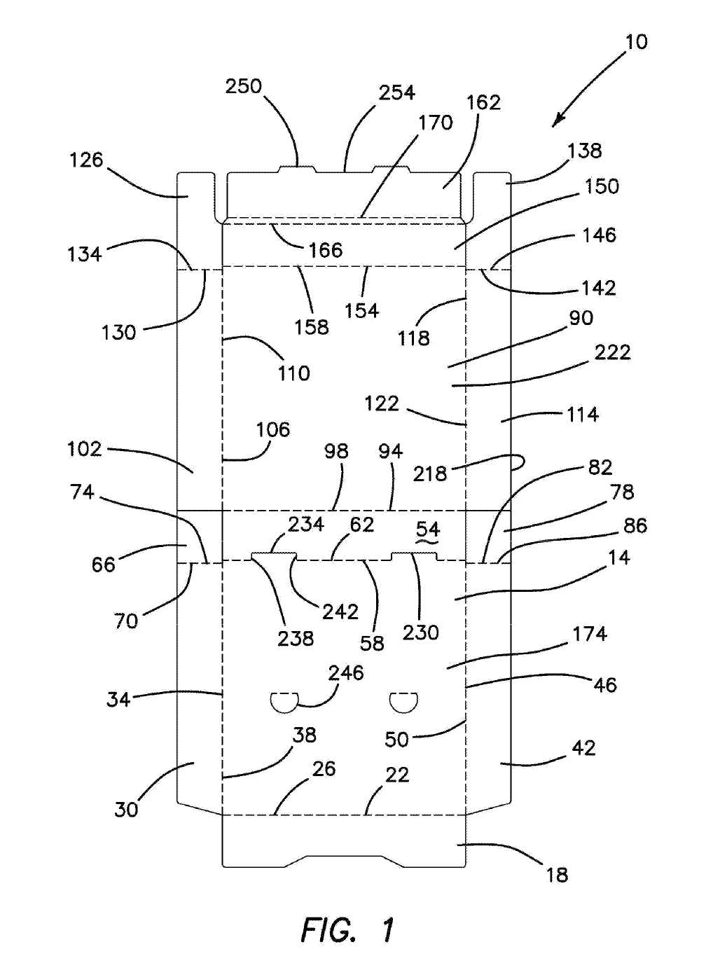

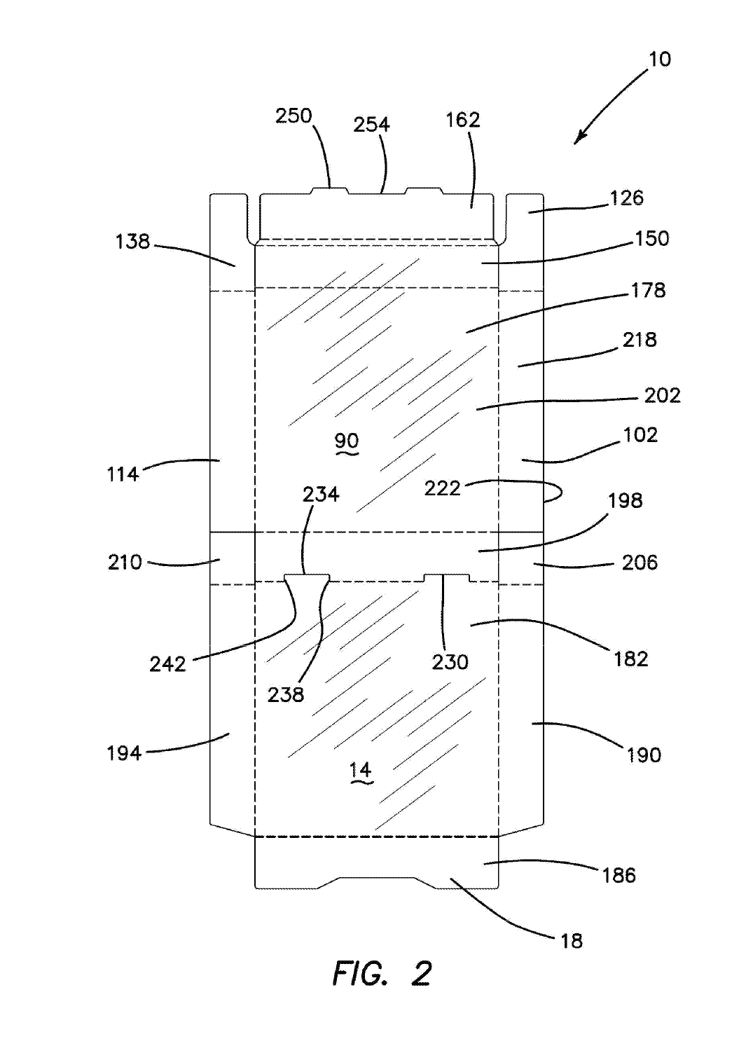

(1) FIGS. 1-2 illustrate a hot pizza box 10 providing the desired features that may be constructed from the following components. A bottom panel 14 is provided. The bottom panel 14 is sized and shaped to support a pizza. A front panel 18 is provided. The front panel 18 is attached to a front edge 22 of the bottom panel 14 along a first perforation line 26. A first bottom side panel 30 is provided. The first bottom side panel 30 is attached to a first side edge 34 of the bottom panel 14 along a second perforation line 38. A second bottom side panel 42 is provided. The second bottom side panel 42 is attached to a second side edge 46 of the bottom panel 14 along a third perforation line 50. A back panel 54 is provided. The back panel 54 is attached to a back edge 58 of the bottom panel 14 along a fourth perforation line 62. A first back panel seal 66 is provided. The first back panel seal 66 is attached to a first end 70 of the first bottom side panel 30 at a fifth perforation line 74. A second back panel seal 78 is provided. The second back panel seal 78 is attached to a first end 82 of the second bottom side panel 42 at a sixth perforation line 86.

A top panel 90 is provided. The top panel 90 is attached at a back edge 94 to the back panel 54 along a seventh perforation line 98. A first top side panel 102 is provided. The first top side panel 102 is attached to a first side edge 106 of the top panel 90 along an eighth perforation line 110. A second top side panel 114 is provided. The second top side panel 114 is attached to a second side edge 118 of the top panel 90 along a ninth perforation line 122. A first lid reinforcing tab 126 is provided. The first lid reinforcing tab 126 is attached to a first end 130 of the first top side panel 102 along a tenth perforation line 134. A second lid reinforcing tab 138 is provided. The second lid reinforcing tab 138 is attached to a first end 142 of the second top side panel 114 along an eleventh perforation line 146. A lid front panel 150 is provided. The lid front panel 150 IS attached to a front edge 154 of the top panel 90 along a twelfth perforation line 158. A lid front panel securing portion 162 is provided. The lid front panel securing portion 162 is attached to the lid front panel 150 along thirteenth 166 and fourteenth 170 parallel perforation lines.

The hot pizza box 10 is formed of corrugated cardboard 174 or paperboard (not shown). The bottom panel 14, front panel 18, first 30 and second 42 bottom side panels, back panel 54, first 66 and second 78 back panel seals, and top panel 90 have an aluminum lining 178 on interior surfaces of the panels 182, 186, 190, 194, 198, 202 and seals 206, 210. The pizza box 10 is formed by folding the front panel 18 to be orthogonal to the bottom panel 14, folding the first 66 and second 78 back panel seals to be orthogonal to the first 30 and second 42 bottom side panels, respectively, folding the first 30 and second 42 bottom side panels to be orthogonal to the bottom panel 14, folding the first 126 and second 138 lid reinforcing tabs to be orthogonal to the first 102 and second 114 top side panels, respectively, folding the first 102 and second 114 top side panels to be orthogonal to the top panel 90, folding the a lid front panel 150 to be orthogonal to the top panel 90, folding the lid front panel securing portion 162 over the first 126 and second 138 lid reinforcing tabs and securing it frictionally to an interior surface 202 of the top panel 90, folding the back panel 54 to be orthogonal to the bottom panel 14 and folding the top panel 90 to be orthogonal to the back panel 54, thereby forming a closed pizza box 10.

(2) In a variant of the invention, as illustrated in FIGS. 2A and 2B, the bottom panel 14, front panel 18, first 30 and second 42 bottom side panels, back panel 54, first 66 and second 78 back panel seals, and top panel 90 further include a second layer of aluminum 214 located between interior 218 and exterior 222 surfaces of the corrugated cardboard 174 or paperboard.

(3) In another variant, as illustrated in FIG. 2A, the second layer of aluminum 214 is located between the interior surface 218 of the corrugated cardboard 174 or paperboard and a corrugated layer of paper 226 within the corrugated cardboard 174 or paperboard.

(4) In still another variant, as illustrated in FIG. 2B, the second layer of aluminum 214 is located between the exterior surface 222 of the corrugated cardboard 174 or paperboard and a corrugated layer of paper 226 within the corrugated cardboard 174 or paperboard.

(5) In yet another variant, as illustrated in FIGS. 1 and 2, at least one interruption 230 in the fourth perforation line 62 is provided. The at least one interruption 230 is formed as a first cut 234 through the back panel 54 parallel to and spaced downwardly from the fourth perforation line 62 and connected to the fourth perforation line 62 by second 238 and third 242 cuts orthogonal to the first cut 234 and the fourth perforation line 62, the first cut 234 reduces the effort required to fold the back panel 54 to be orthogonal to the bottom panel 14.

(6) In a further variant, at least one vent opening 246 is provided. The vent opening 246 is located in either of the top panel 90 or the bottom panel 14.

(7) In still a further variant, at least one securing protrusion 250 is provided. The first securing protrusion 250 extends outwardly from a distal edge 254 of the lid front panel securing portion 162 and is adapted to facilitate frictionally securing the lid front panel securing portion 162 to the interior surface 202 of the top panel 90.

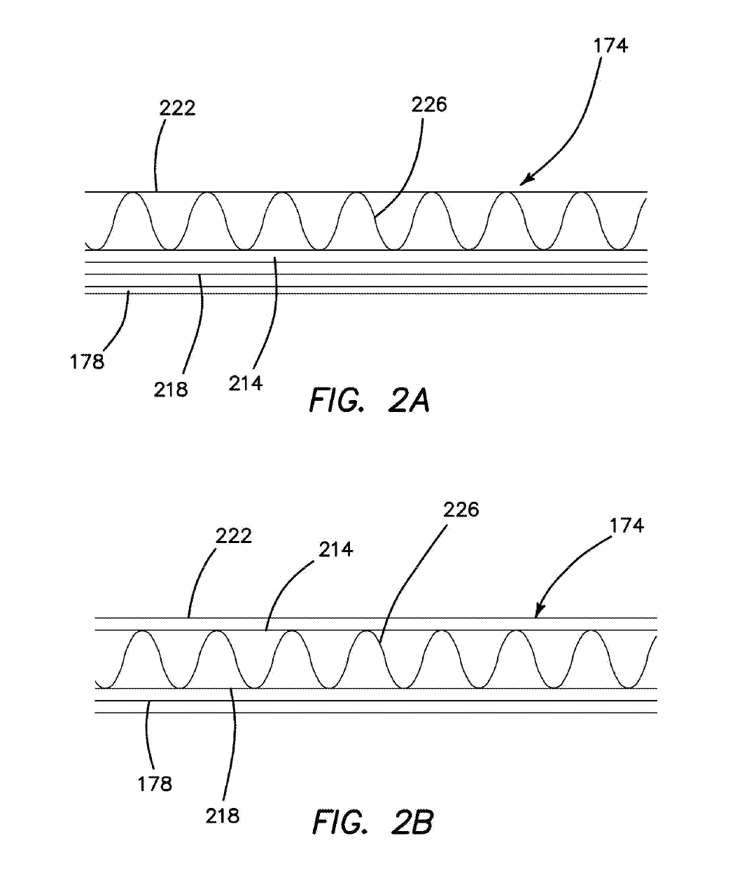

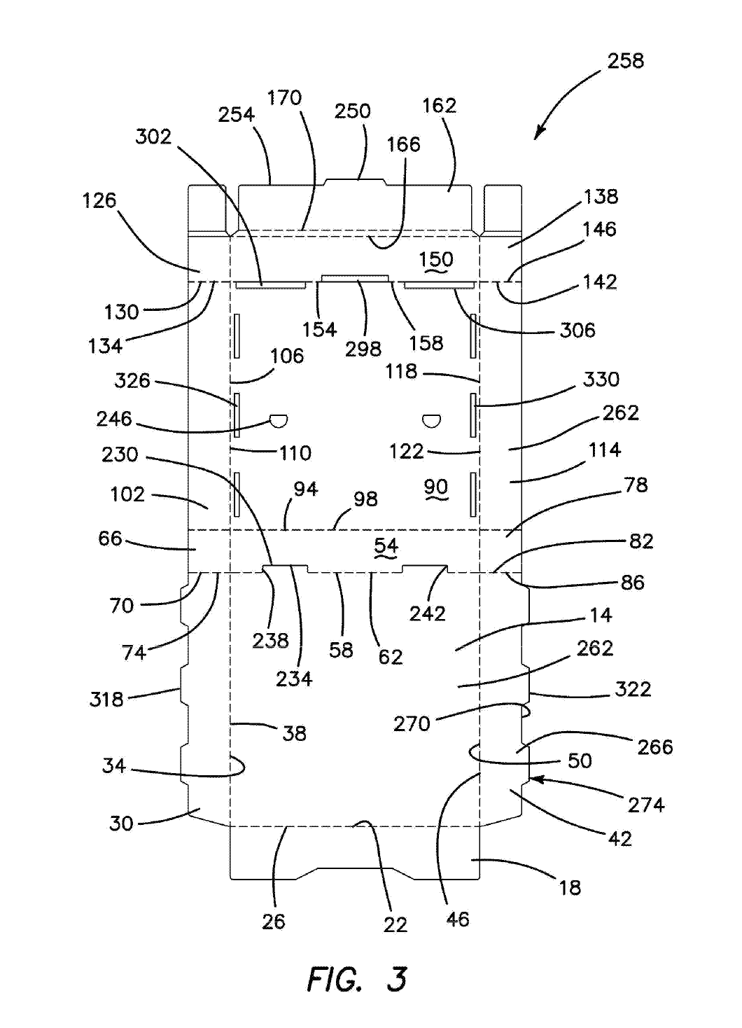

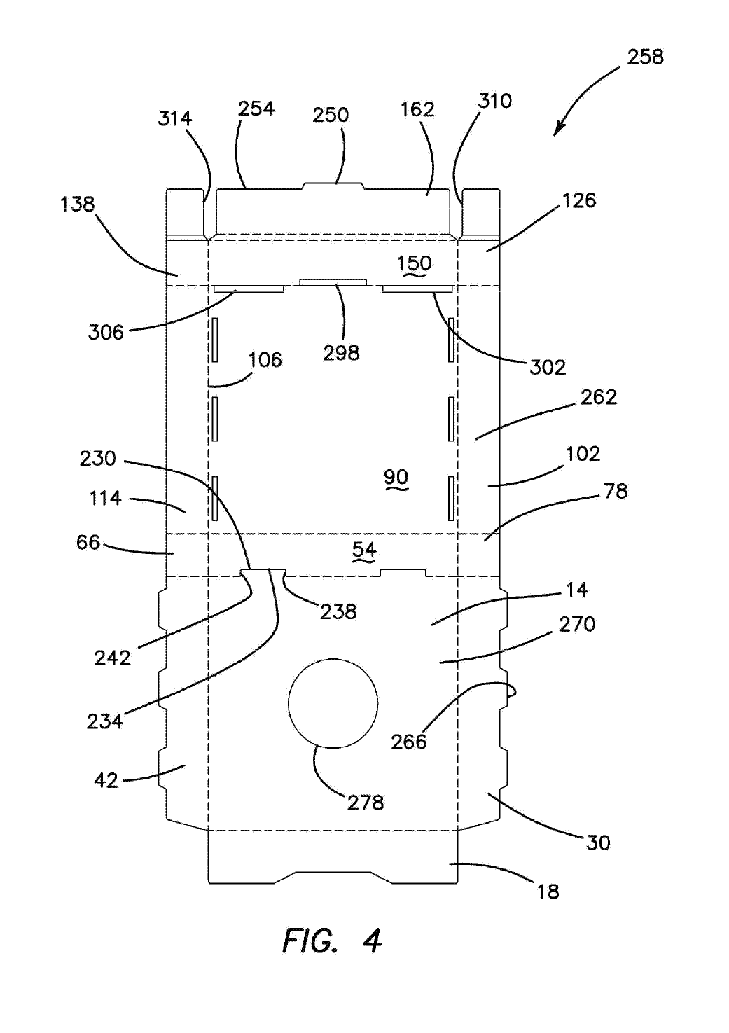

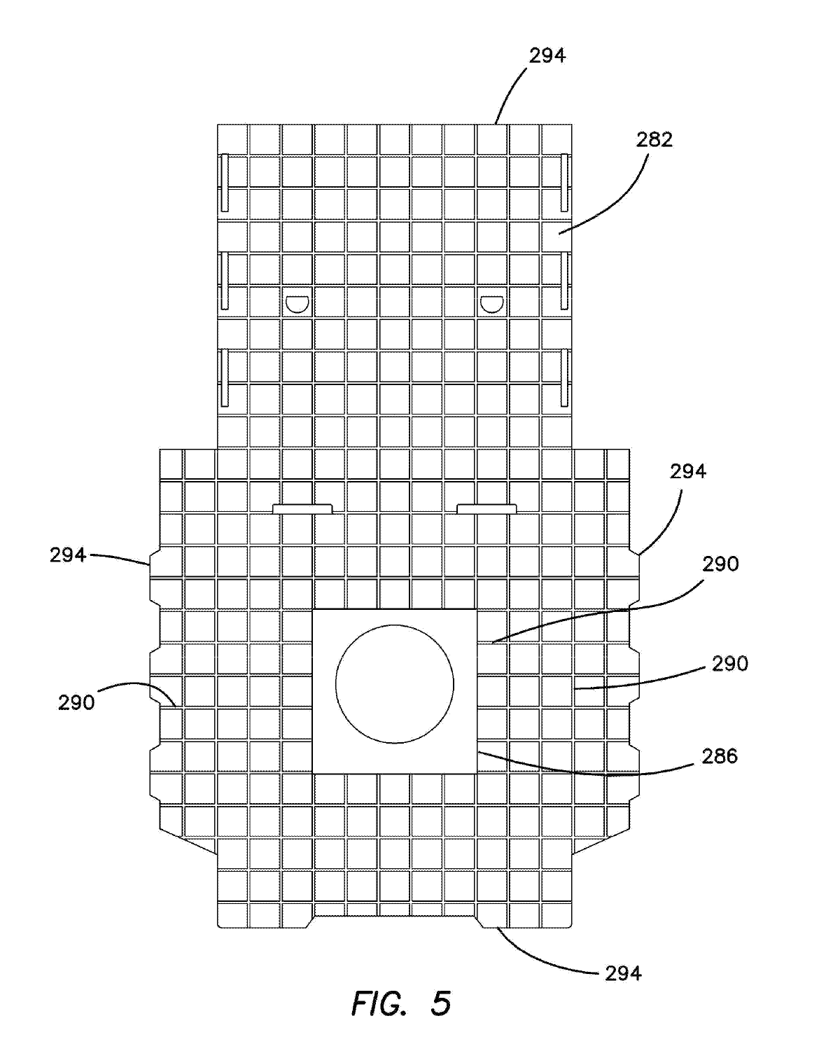

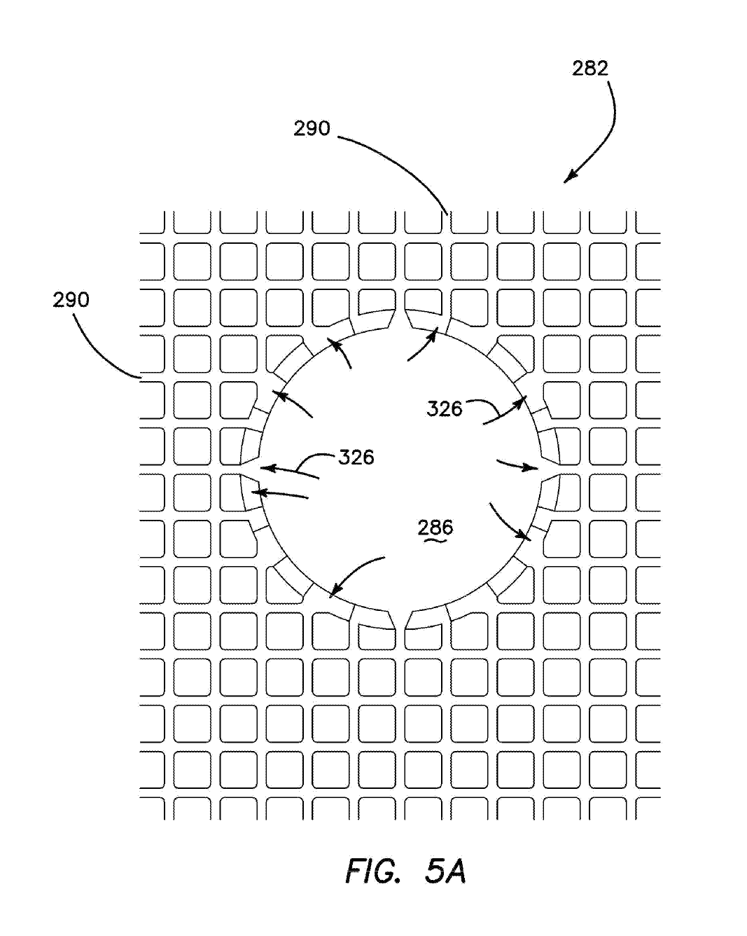

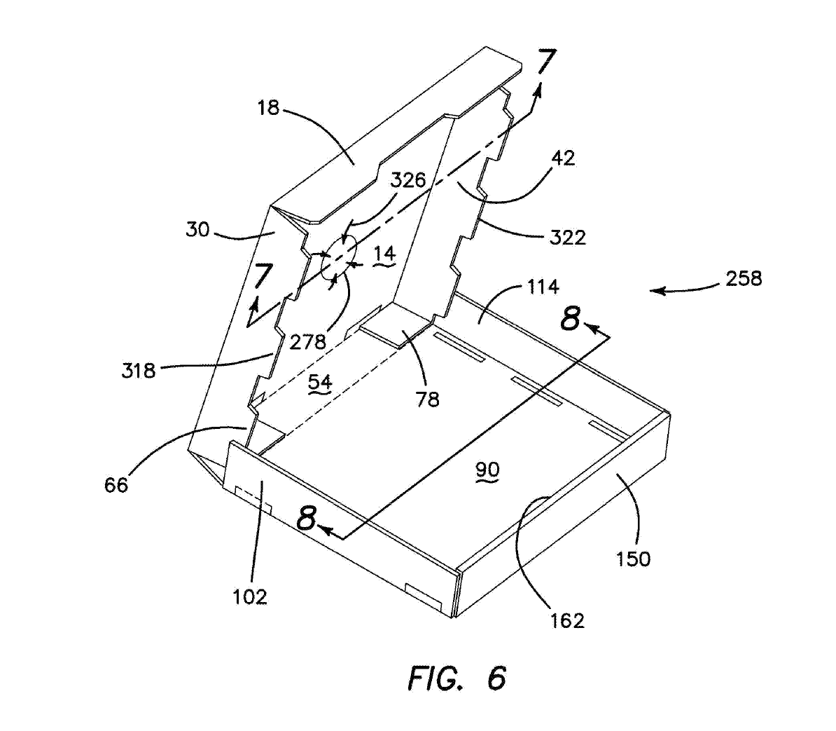

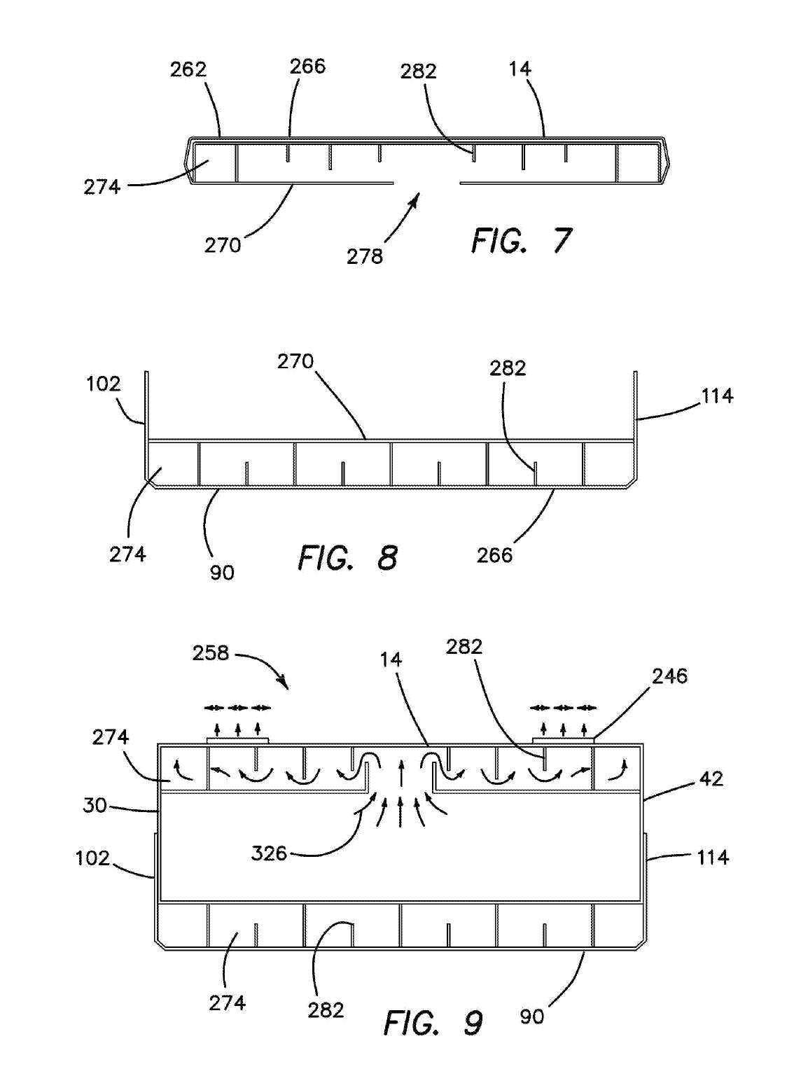

(8) In yet a further variant, as illustrated in FIGS. 3-9, an alternative hot pizza box 258, includes the following components. A bottom panel 14 is provided. The bottom panel 14 is sized and shaped to support a pizza. A front panel 18 is provided. The front panel 18 is attached to a front edge 22 of the bottom panel 14 along a first perforation line 26. A first bottom side panel 30 is provided. The first bottom side panel 30 is attached to a first side edge 34 of the bottom panel 14 along a second perforation line 38. A second bottom side panel 42 is provided. The second bottom side panel 42 is attached to a second side edge 46 of the bottom panel 14 along a third perforation line 50. A back panel 54 is provided. The back panel 54 is attached to a back edge 58 of the bottom panel 14 along a fourth perforation line 62. A first back panel seal 66 is provided. The first back panel seal 66 is attached to a first end 70 of the first bottom side panel 30 at a fifth perforation line 74. A second back panel seal 78 is provided. The second back panel seal 78 is attached to a first end 82 of the second bottom side panel 42 at a sixth perforation line 86.

A top panel 90 is provided. The top panel 90 is attached at a back edge 94 to the back panel 54 along a seventh perforation line 98. A first top side panel 102 is provided. The first top side panel 102 is attached to a first side edge 106 of the top panel 90 along an eighth perforation line 110. A second top side panel 114 is provided. The second top side panel 114 is attached to a second side edge 118 of the top panel 90 along a ninth perforation line 122. A first lid reinforcing tab 126 is provided. The first lid reinforcing tab 126 is attached to a first end 130 of the first top side panel 102 along a tenth perforation line 134. A second lid reinforcing tab 138 is provided. The second lid reinforcing tab 138 is attached to a first end 142 of the second top side panel 114 along an eleventh perforation line 146. A lid front panel 150 is provided. The lid front panel 150 IS attached to a front edge 154 of the top panel 90 along a twelfth perforation line 158. A lid front panel securing portion 162 is provided. The lid front panel securing portion 162 is attached to the lid front panel 150 along thirteenth 166 and fourteenth 170 parallel perforation lines.

The hot pizza box 258 is formed of resilient material 262 and has an exterior member 266 and an interior member 270. The members 266, 270 are spaced apart to form an interior cavity 274. The bottom panel 14 has a central aperture 278. The aperture 278 penetrates only the interior member 270. The bottom panel 14, front panel 18, first 30 and second 42 bottom side panels, back panel 54, first 66 and second 78 back panel seals, and top panel 90 have a formed aluminum panel 282 located between the interior 270 member and the exterior member 266.

The pizza box 258 is formed by folding the front panel 18 to be orthogonal to the bottom panel 14, folding the first 66 and second 78 back panel seals to be orthogonal to the first 30 and second 42 bottom side panels, respectively, folding the first 30 and second 42 bottom side panels to be orthogonal to the bottom panel 14, folding the first 126 and second 138 lid reinforcing tabs to be orthogonal to the first 102 and second 114 top side panels, respectively, folding the first 102 and second 114 top side panels to be orthogonal to the top panel 90, folding the a lid front panel 150 to be orthogonal to the top panel 90, folding the lid front panel securing portion 162 over the first 126 and second 138 lid reinforcing tabs and securing it frictionally to an interior surface 202 of the top panel 90, folding the back panel 54 to be orthogonal to the bottom panel 14 and folding the top panel 90 to be orthogonal to the back panel 54, thereby forming a closed pizza box 258.

(9) In another variant of the invention, the formed aluminum panel 282 further includes a mating recess 286. The recess 286 is sized and shaped to align with the aperture 278 in the bottom panel 14;

(10) In still another variant, the formed aluminum panel 282 further includes a series of channels 290. The channels 290 are adapted to augment heat flow from the aperture 278 to distal ends 294 of the aluminum panel 282, thereby distributing heat 326 to the panels 14, 18, 30, 42, 54, 90 and seals 66, 78 of the pizza box 258.

(11) In yet another variant, at least one interruption 230 in the fourth perforation line 62 is provided. The at least one interruption 230 is formed as a first cut 234 through the back panel 54 parallel to and spaced downwardly from the fourth perforation line 62 and connected to the fourth perforation line 62 by second 238 and third 242 cuts orthogonal to the first cut 234 and the fourth perforation line 62, the first cut 234 reduces the effort required to fold the back panel 54 to be orthogonal to the bottom panel 14.

(12) In a further variant, at least one vent opening 246 is provided. The vent opening 246 is located in either of the top panel 90 or the bottom panel 14.

(13) In still a further variant, at least one securing protrusion 250 is provided. The first securing protrusion 250 extends outwardly from a distal edge 254 of the lid front panel securing portion 162. A first receiving notch 298 is provided. The first receiving notch 298 penetrates only the interior member 270 of the top panel 90 and is located and adapted to receive frictionally the first securing protrusion 250.

(14) In yet a further variant, second 302 and third 306 receiving notches are provided. The second 302 and third 306 receiving notches penetrate the top panel 90 and are located and adapted to receive frictionally inner edges 310, 314 of the first 126 and second 138 lid reinforcing tabs.

(15) In a final variant of the invention, at least one first bottom side panel securing tab 318 and at least one second bottom side panel securing tab 322 are provided. The first 318 and second 322 bottom side panel securing tabs extend upwardly to form the first 30 and second 42 bottom side panels, respectively. At least one first bottom side panel receiving notch 326 and at least one second bottom side panel receiving notch 330 are provided. The first 326 and second 330 bottom side panel receiving notches penetrate the top panel 90 and are located and adapted to receive frictionally the first 318 and second 322 bottom side panel securing tabs, respectively, thereby securing the top panel 90 over the bottom panel 14.

An appreciation of the other aims and objectives of the present invention and an understanding of it may be achieved by referring to the accompanying drawings and the detailed description of a preferred embodiment.

The hot pizza boxes 10 and 258 have been described with reference to particular embodiments. Other modifications and enhancements can be made without departing from the spirit and scope of the claims that follow.

1. A hot pizza box comprising:
a bottom panel, said bottom panel sized and shaped to support a pizza;
a front panel, said front panel attached to a front edge of said bottom panel along a first perforation line;
a first bottom side panel, said first bottom side panel attached to a first side edge of said bottom panel along a second perforation line;
a second bottom side panel, said second bottom side panel attached to a second side edge of said bottom panel along a third perforation line;
a back panel, said back panel attached to a back edge of said bottom panel along a fourth perforation line;
a first back panel seal, said first back panel seal attached to a first end of said first bottom side panel at a fifth perforation line;
a second back panel seal, said second back panel seal attached to a first end of said second bottom side panel at a sixth perforation line;
a top panel, said top panel attached at a back edge to said back panel along a seventh perforation line;
a first top side panel, said first top side panel attached to a first side edge of said top panel along an eighth perforation line;
a second top side panel, said second top side panel attached to a second side edge of said top panel along a ninth perforation line;
a first lid reinforcing tab, said first lid reinforcing tab attached to a first end of said first top side panel along a tenth perforation line;
a second lid reinforcing tab, said second lid reinforcing tab attached to a first end of said second top side panel along an eleventh perforation line;
a lid front panel, said lid front panel attached to a front edge of said top panel along a twelfth perforation line;
a lid front panel securing portion, said lid front panel securing portion attached to said lid front panel along thirteenth and fourteenth parallel perforation lines;
said pizza box being formed of corrugated cardboard or paperboard;
said bottom panel, front panel, first and second bottom side panels, back panel, first and second back panel seals, and top panel having an aluminum lining on interior surfaces of said panels and seals; and
said pizza box being formed by folding said front panel to be orthogonal to said bottom panel, folding said first and second back panel seals to be orthogonal to said first and second bottom side panels, respectively, folding said first and second bottom side panels to be orthogonal to said bottom panel, folding said first and second lid reinforcing tabs to be orthogonal to said first and second top side panels, respectively, folding said first and second top side panels to be orthogonal to said top panel, folding said a lid front panel to be orthogonal to said top panel, folding said lid front panel securing portion over said first and second lid reinforcing tabs and securing it frictionally to an interior surface of said top panel, folding said back panel to be orthogonal to said bottom panel and folding said top panel to be orthogonal to said back panel, thereby forming a closed pizza box.
